(19) United States
(12) Patent Application Publication
(10) Pub. No.: US 2022/0058595 A1
(43) Pub. Date: Feb. 24, 2022

(54) Method of sending Cryptocurrencies to a custom username attached to a fixed wallet address.

(71) Applicant: Callum Tony Evans, Newport Beach, CA (US)

(72) Inventor: Callum Tony Evans, Newport Beach, CA (US)

(21) Appl. No.: 17/221,557

(22) Filed: Apr. 2, 2021

Related U.S. Application Data
(60) Provisional application No. 63/068,455, filed on Aug. 21, 2020.

(51) Int. Cl. G06Q 20/06; G06Q 20/40; G06Q 20/38; G06Q 20/36

(52) U.S. Cl. CPC G06Q 20/065; G06Q 20/4014; G06Q 20/3674; G06Q 20/3827; G06Q 20/405

(57) ABSTRACT

A method for receiving cryptocurrency includes creating an account and a custom username for a user associated with the account; creating tickered usernames by combining a unique ticker and the custom username, each of the tickered usernames corresponding to a different type of cryptocurrency; and receiving, by the user, cryptocurrency sent to one of the tickered usernames, the cryptocurrency being of a type corresponding to the one of the tickered usernames.

### BACKGROUND OF THE INVENTION

### 1. Field

The present invention relates to transferring cryptocurrencies, and more particularly, to transferring of cryptocurrencies to a custom username attached to a fixed wallet address.

### 2. Discussion of the Related Art

When a party sends cryptocurrency to another, they have to enter in the wallet address of that receiving party. This wallet address has to be designed for the relevant cryptocurrency being transmitted. This process is lengthy as it requires the pre-communication/transmission of the receiving wallet address. Cryptocurrency addresses are lengthy and complex. This means they can easily be sent with errors or, in some instances, the incorrect wallet for the intended cryptocurrency can be sent. Both situations lead to a failed transaction or loss of the currency. Conventional methods involve users having to exchange and/or enter in complex wallet addresses, including some currencies which use alternate chains for the same currency.

Entering in a wallet address can be complex as it leaves room for errors in the copy/past method currently used. Additionally, there is a security issue with transmitting a wallet address through a medium of communication so that funds can be sent through to the user. Financial institutions advise clients never to send banking information. The same is true of Cryptocurrency wallet information.

The method according to the present invention involves attaching a wallet to a username so that receiving parties can easily eliminate the possible error of sending a currency to the wrong wallet address. Users will no longer need to copy and paste lengthy, complex wallet addresses. There will be a much lesser chance of cryptocurrencies being lost in transmission due to the wrong information being given or wrong wallet address being entered.

### SUMMARY OF THE INVENTION

According to one embodiment, a method for receiving cryptocurrency includes creating an account and a custom username for a user associated with the account; creating tickered usernames by combining a unique ticker and the custom username, wherein each of the tickered usernames corresponds to a different type of cryptocurrency; and receiving, by the user, cryptocurrency sent to one of the tickered usernames, wherein the cryptocurrency is of a type corresponding to the one of the tickered usernames.

The creating of the tickered usernames may include combining a first ticker with the username to create a tickered Ripple username, combining a second ticker with the username to create a tickered Bitcoin username, and combining a third ticker with the username to create a tickered Ethereum username. Ripple may be received at the tickered Ripple username, Bitcoin may be received at the tickered Bitcoin username, and Ethereum may be received at the tickered Ethereum username. Each of the tickered usernames may include the custom username, an ‘@’ symbol, and the unique ticker. The method may further include allocating the received cryptocurrency to a wallet of the user.

According to another embodiment, a method of sending cryptocurrency includes sending cryptocurrency to a tickered username of a recipient, wherein a custom username for the recipient is associated with an account of the recipient, tickered usernames for the recipient include a unique ticker and the custom username, each of the tickered usernames corresponds to a different type of cryptocurrency, the cryptocurrency is sent to one of the tickered usernames, and the cryptocurrency is of a type corresponding to the one of the tickered usernames.

The tickered usernames may include a tickered Ripple username, a tickered Bitcoin username, and a tickered Ethereum username. The tickered Ripple username may include a Ripple ticker and the username, the tickered Bitcoin username may include a Bitcoin ticker and the username, and the tickered Ethereum username may include an Ethereum ticker and the username. Ripple may be sent to the tickered Ripple username, Bitcoin may be sent to the tickered Bitcoin username, and Ethereum may be sent to the tickered Ethereum username. Each of the tickered usernames includes the custom username, an ‘@’ symbol, and the unique ticker. The sent cryptocurrency may be received at the one of the tickered usernames, and the cryptocurrency is allocated to a wallet of the user.

According to yet another embodiment, an apparatus for receiving cryptocurrency includes one or more processors configured to create an account and a custom username for a user associated with the account; create tickered usernames by combining a unique ticker and the custom username, wherein each of the tickered usernames corresponds to a different type of cryptocurrency; and enable the user to receive cryptocurrency sent to one of the tickered usernames, wherein the cryptocurrency is of a type corresponding to the one of the tickered usernames.

The creation of the tickered usernames may include combining a first ticker with the username to create a tickered Ripple username, combining a second ticker with the username to create a tickered Bitcoin username, and combining a third ticker with the username to create a tickered Ethereum username. Ripple may be received at the tickered Ripple username, Bitcoin may be received at the tickered Bitcoin username, and Ethereum may be received at the tickered Ethereum username. Each of the tickered usernames includes the custom username, an ‘@’ symbol, and the unique ticker. The one or more processors are further configured to allocate the received cryptocurrency to a wallet of the user.

### BRIEF DESCRIPTION OF THE DRAWINGS

A full and enabling disclosure of the present invention, including the best mode thereof to one of ordinary skill in the art, is set forth more particularly in the remainder of the specification, including reference to the accompanying figures in which:

FIG. 1 is a diagram showing a setup layer for sending cryptocurrency to a username according to an embodiment of the present invention.

FIG. 2 is a diagram illustrating a method for sending cryptocurrency to a username according to an embodiment of the present invention.

### DETAILED DESCRIPTION OF THE INVENTION

Reference will now be made in detail to the embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment may be used on another embodiment to yield a still further embodiment. Thus, it is intended that the present invention cover such modifications and variations as come within the scope of the appended claims and their equivalents.

By attaching the user's fixed wallet address to a custom user name (unique for the requisite cryptocurrency), parties can provide their custom username for the sending party in place of a complex wallet address. Each username would begin with a denomination of the specific currency. In allowing a party to provide a custom username there is reduced chance the wrong address could be entered by the sending party. Additionally, the pre-communication of receiving address (party) is much easier.

The present invention connects a fixed wallet address to a fixed user name. So, parties never share wallet addresses, just user names. It enables much easier transmission of cryptocurrencies between parties.

Users will no longer need to copy and paste lengthy, complex wallet addresses. There will be a much lesser chance of cryptocurrencies being lost in transmission due to the wrong information being given or a wrong wallet address being entered.

The present invention includes a fixed cryptocurrency wallet address linked to a unique username for the respective wallet. According to an embodiment, the present invention may further include a fixed cryptocurrency wallet address linked to a unique username, which includes three elements: (1) a ‘@’ sign; (2) the currency ‘ticker’, and (3) the user's unique identifying name.

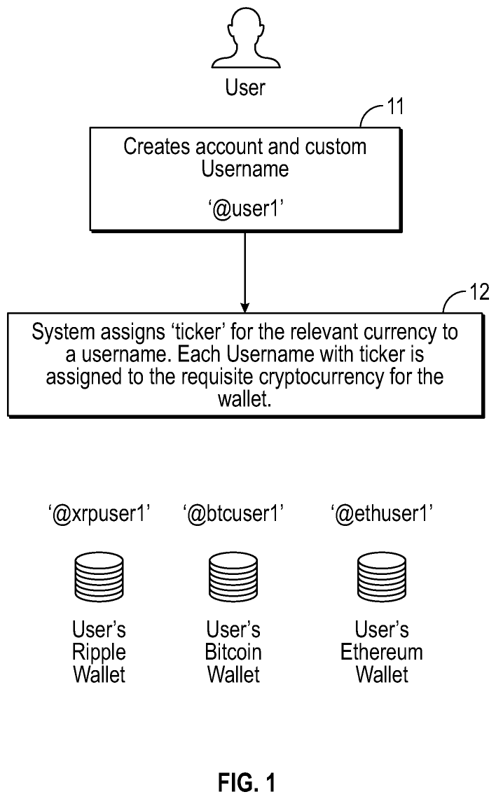

A unique username is created for a corresponding fixed cryptocurrency wallet address. It is designed to make it easier for the user to receive the requisite cryptocurrency. Referring to FIG. 1, at step 11, the user first creates an account and custom username.

The receiving party sets up a unique username for each cryptocurrency wallet they intend to use. An example would be @BTCUSER, which would be the denomination for the user's Bitcoin address. This username would act as the sending address for Bitcoin for this user, as opposed to the user providing a whole complex bitcoin address to receive Bitcoin. A Bitcoin wallet would then be attached to the username, and the system would send funds transmitted to this username directly to the attached wallet. Although Bitcoin is used throughout the specification as an example, it is within the scope of the present invention that any cryptocurrency be used.

A fixed cryptocurrency wallet address is linked to a unique username. The username denotes the type of currency and the user who will receive it. The user can provide this username in place of a wallet address. The system will forward/transmit payments received to that username to the wallet address.

The present invention may be implemented as a custom wallet platform. Each user of the platform will create a username for the specific currency they wish to use within the wallet platform. At step 12, the system assigns a ‘ticker’ for the relevant currency to a username, and each username with the ticker is assigned to the requisite cryptocurrency for the wallet. Each username will feature the same ‘unique user name’ but different ‘currency ticker.’ Both of these together will form the username. The user can then provide others with their currency username for the currency they wish to receive.

In adding the ‘ticker’ at the start of the username, the system will block transactions of any other currency from being transacted to that username. For example, it would be impossible to start a BTC transfer to an @ETH username.

The custom username may include (1) ‘@’ sign; (2) the currency denomination (ticker); and (3) the user individual username. This username may be linked to a fixed cryptocurrency address for the requisite cryptocurrency. The system may forward/send the cryptocurrency sent to this address to the wallet linked to it. It may require that the correct cryptocurrency be sent to it.

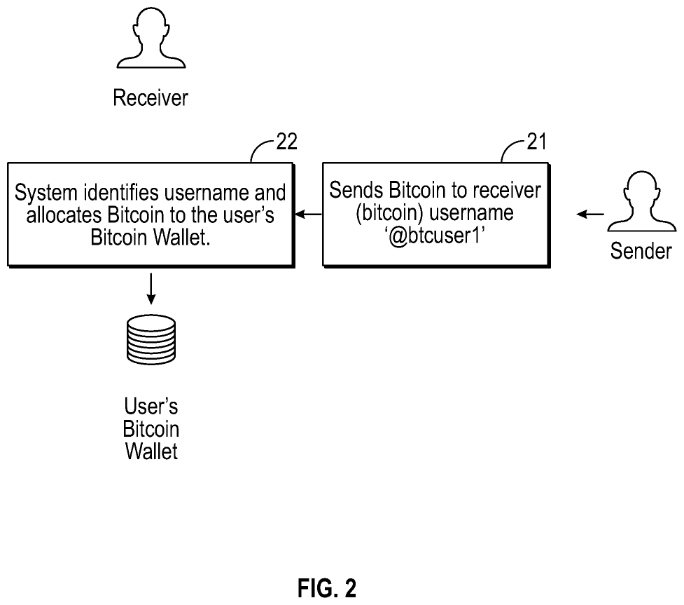

Referring now to FIG. 2, at step 21, the sender sends Bitcoin to receiver (bitcoin) username ‘@btcuser1’. Next, at step 22, the system identifies the username and allocates Bitcoin to the user's Bitcoin Wallet. The user can receive cryptocurrencies by providing a unique username, rather than sending a complex wallet address which gives room for error. It also adds in a layer of privacy.

According to an embodiment, the system only allows the requisite cryptocurrency to be sent to the requisite address. For example, if a user attempts to send BTC to a @ETH address, the system will physically block the user from starting the transaction (as the system would recognize the error).

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A method for receiving cryptocurrency, the method comprising:
creating an account and a custom username for a user associated with the account;
creating tickered usernames by combining a unique ticker and the custom username, wherein each of the tickered usernames corresponds to a different type of cryptocurrency; and
receiving, by the user, cryptocurrency sent to one of the tickered usernames, wherein the cryptocurrency is of a type corresponding to the one of the tickered usernames.

2. The method of claim 1, wherein the creating of the tickered usernames comprises combining a first ticker with the username to create a tickered Ripple username, combining a second ticker with the username to create a tickered Bitcoin username, and combining a third ticker with the username to create a tickered Ethereum username.

3. The method of claim 2, wherein Ripple is received at the tickered Ripple username, Bitcoin is received at the tickered Bitcoin username, and Ethereum is received at the tickered Ethereum username.

4. The method of claim 1, wherein each of the tickered usernames includes the custom username, an ‘@’ symbol, and the unique ticker.

5. The method of claim 1, further comprising allocating the received cryptocurrency to a wallet of the user.

6. A non-transitory computer-readable medium storing instructions that, when executed by a processor, cause the processor to perform the method of claim 1.

7. A method of sending cryptocurrency, the method comprising:
sending cryptocurrency to a tickered username of a recipient, wherein
a custom username for the recipient is associated with an account of the recipient,
tickered usernames for the recipient include a unique ticker and the custom username,
each of the tickered usernames corresponds to a different type of cryptocurrency,
the cryptocurrency is sent to one of the tickered usernames, and
the cryptocurrency is of a type corresponding to the one of the tickered usernames.

8. The method of claim 7, wherein
the tickered usernames include a tickered Ripple username, a tickered Bitcoin username, and a tickered Ethereum username,
the tickered Ripple username includes a Ripple ticker and the username,
the tickered Bitcoin username includes a Bitcoin ticker and the username, and
the tickered Ethereum username includes an Ethereum ticker and the username.

9. The method of claim 8, wherein Ripple is sent to the tickered Ripple username, Bitcoin is sent to the tickered Bitcoin username, and Ethereum is sent to the tickered Ethereum username.

10. The method of claim 7, wherein each of the tickered usernames includes the custom username, an ‘@’ symbol, and the unique ticker.

11. The method of claim 7, wherein the sent cryptocurrency is received at the one of the tickered usernames, and the cryptocurrency is allocated to a wallet of the user.

12. A non-transitory computer-readable medium storing instructions that, when executed by a processor, cause the processor to perform the method of claim 7.

13. An apparatus for receiving cryptocurrency, the apparatus comprising:
one or more processors configured to:
create an account and a custom username for a user associated with the account;
create tickered usernames by combining a unique ticker and the custom username, wherein each of the tickered usernames corresponds to a different type of cryptocurrency; and
enable the user to receive cryptocurrency sent to one of the tickered usernames, wherein the cryptocurrency is of a type corresponding to the one of the tickered usernames.

14. The method of claim 13, wherein the creation of the tickered usernames comprises combining a first ticker with the username to create a tickered Ripple username, combining a second ticker with the username to create a tickered Bitcoin username, and combining a third ticker with the username to create a tickered Ethereum username.

15. The method of claim 14, wherein Ripple is received at the tickered Ripple username, Bitcoin is received at the tickered Bitcoin username, and Ethereum is received at the tickered Ethereum username.

16. The method of claim 13, wherein each of the tickered usernames includes the custom username, an ‘@’ symbol, and the unique ticker.

17. The method of claim 13, wherein the one or more processors are further configured to allocate the received cryptocurrency to a wallet of the user.
